(19) United States
(12) Patent Application Publication
(10) Pub. No.: US 2025/0297960 A1
(43) Pub. Date: Sep. 25, 2025

(54) LASER IMAGING AND RAMAN SCATTERING APPARATUS AND METHOD

(71) Applicant: UCHICAGO ARGONNE, LLC, Chicago, IL (US)

(72) Inventors: Jiefei ZHANG, Naperville, IL (US); Yuepeng ZHANG, Naperville, IL (US); Jungkuk LEE, Naperville, IL (US)

(73) Assignee: UCHICAGO ARGONNE, LLC, Chicago, IL (US)

(21) Appl. No.: 19/089,433

(22) Filed: Mar. 25, 2025

Related U.S. Application Data
(60) Provisional application No. 63/569,267, filed on Mar. 25, 2024.

(51) Int. Cl. G01N 21/65; B05C 5/02; B05C 11/00; G01B 11/06; G01N 21/89

(52) U.S. Cl. CPC G01N 21/65; B05C 5/0245; B05C 5/0254; B05C 11/00; G01B 11/0616; G01B 11/0691; G01N 21/8901; G01N 2201/06113; G01N 2201/0636; G01N 2201/08

(57) ABSTRACT

An apparatus suitable for defect monitoring of continuous coating processes is described herein. The apparatus comprises a first beam splitter; an objective lens assembly; a scanning mirror interposed between the first beam splitter and the objective lens assembly; a dichroic filter that is positioned between the first beam splitter and the scanning mirror; and a second beam splitter. In use, a laser emits light toward the first beam splitter. The light passes through the first beam splitter and the dichroic filter to the scanning mirror and then through the objective lens assembly onto a Raman-active analyte in a coating. Raman scattering from the analyte passes through the objective lens assembly to the scanning mirror and then to the dichroic filter, directing the scattered light to the second beam splitter and then to the detector to quantitatively detect the Raman-scattered light.

### CROSS-REFERENCE TO RELATED APPLICATIONS

This application claims the benefit of U.S. Provisional Application Ser. No. 63/569,267, filed on Mar. 25, 2024, which is incorporated herein by reference in tis entirety.

### CONTRACTUAL ORIGIN OF THE INVENTION

The United States Government has rights in this invention pursuant to Contract No. DE-AC02-06CH11357 between the United States Government and UChicago Argonne, LLC representing Argonne National Laboratory.

### FIELD OF THE INVENTION

This invention relates to methods and apparatus for in-line defect monitoring of continuous coating deposition processes using Raman scattering.

### BACKGROUND OF THE INVENTION

Real time control and feedback on coating quality using non-destructive measurements is an important goal in coating process quality control (GC). QC methods for microstructural defect identification and composition uniformity are essential for roll-to-roll manufacturing processes, in particular. Traditionally, sample testing is performed “offline” and applied to selected pieces (i.e., testing is performed in a QC lab on selected coating samples), which is time consuming and often requires interrupting the manufacturing process. The reliability of such testing results depends on sampling number and statistics. Already known techniques for large-scale surface defect detection are often expensive, requiring bulky instruments, and some use destructive measurements preventing them from being used in situ for in-process feedback. There is an ongoing need for alternative apparatus and methods for in-line/in situ non-destructive coating defect detection, coating composition uniformity monitoring, and/or detecting or monitoring other chemical changes of materials during coating fabrication. The apparatus and methods described herein address this need.

### SUMMARY OF THE INVENTION

An apparatus suitable, e.g., for defect monitoring of continuous coating processes is described herein. The apparatus comprises a laser; a first beam splitter that is adapted and arranged to reflect a beam of laser light emitted from the laser; and an objective lens assembly. A scanning mirror is interposed between the first beam splitter and the objective lens assembly. The scanning mirror is adapted and arranged to continuously scan the beam of laser light through the objective lens assembly. A dichroic filter that is transparent to the laser light and reflective to Raman-scattered light from a Raman-active analyte illuminated by the laser light is positioned between the first beam splitter and the scanning mirror. A second beam splitter is aligned with the dichroic filter to direct Raman-scattered light to a spectrophotometric detector that is capable of quantitatively detecting the Raman-scattered light.

In a typical use, the apparatus is operably mounted on a support framework for two- or three-dimensional movement above the coating web of a continuous coating apparatus, such as a roll-to-roll coating apparatus. The first beam splitter directs a beam of laser light through the dichroic filter to the scanning mirror. The scanning mirror continuously scans the beam of the laser light through the objective lens assembly across the width of a coating comprising the analyte, which has been deposited on a moving web of a coating apparatus. Laser light illuminating the coating is Raman-scattered by the analyte, and at least a portion of the Raman-scattered light is directed by the objective lens assembly to the scanning mirror, which then reflects the Raman-scattered light to the dichroic filter. The dichroic filter reflects the Raman-scattered light to the second beam splitter, and the second beam splitter directs the Raman-scattered light to the spectrophotometric detector. The wavelengths of the Raman-scattered light depend on the particular analyte being monitored, and the dichroic filter is selected to be reflective to the Raman-scattered light.

In some embodiments, the apparatus can include a lamp aligned to transmit light through the first beam splitter and the dichroic filter to the scanning mirror, and from the scanning mirror through the objective lens assembly to illuminate the coating surface. Light reflected from the surface of the coating passes back through the objective lens assembly to the scanning mirror, where the light is reflected to the dichroic filter and from the dichroic filter through the second beam splitter to an imager (e.g., a video imager) aligned with the dichroic filter and second beam splitter to receive the light that is reflected from the surface of the coating and record a visual image of the surface of the coating. The lamp and the laser are operated alternately depending on whether the coating is being monitored visually by the imager, or by Raman scattering data recorded by the detector.

In some embodiments, the apparatus is mounted for two-dimensional movement in a plane that is substantially uniformly spaced from the surface of the coating web and/or for or three-dimensional movement over the coating web. For example, the apparatus can be mounted on a movable carriage or on an articulating arm suspended over the coating web.

The apparatus and methods described herein are applicable to a wide range of industrial roll-to-roll deposition processes, such as coating, painting, and membranes. Typical applications include coating of lithium battery electrodes, solid-electrolytes, fuel cell electrodes, polymer electrolyte membranes, OLED films, composite water filtration membranes, surface coating, and painting of large parts, to name but a few. The low cost of the design makes it easily accessible to researchers and industrial coating operations alike.

The following non-limiting embodiments are set forth below to highlight certain features and aspects of the membranes described herein.

Embodiment 1 is an apparatus comprising:
(a) a first beam splitter mounted on a support framework, the first beam splitter being adapted and arranged to receive a beam of laser light emitted from a laser;
(b) a scanning mirror mounted on the support framework;
(c) an objective lens assembly mounted on the support framework optically aligned with the scanning mirror to receive light reflected from the scanning mirror; the scanning mirror being adapted and arranged for rotational movement to scan the beam of laser light through the objective lens assembly;
(d) a dichroic filter mounted on the support framework interposed between and optically aligned with the first beam splitter and the scanning mirror; the dichroic filter being transparent to the beam of laser light and reflective to Raman-scattered light from a Raman-active analyte illuminated by the beam of laser light; and
(e) a second beam splitter mounted on the support framework spaced from and optically aligned with the dichroic filter to reflect the Raman-scattered light to a spectrophotometric detector to collect Raman spectral data;
wherein, in use, the apparatus is optically connected to a laser that emits the beam of laser light toward the first beam splitter, which directs the beam of laser light through the dichroic filter to the scanning mirror; the scanning mirror rotates to continuously scan the beam of laser light through the objective lens assembly across the width of a coating comprising the analyte, which has been deposited on a moving web by a continuous coating apparatus; at least a portion of the Raman-scattered light from the analyte in the coating is directed by the objective lens assembly to the scanning mirror; the scanning mirror reflects the Raman-scattered light to the dichroic filter; the dichroic filter reflects the Raman-scattered light to the second beam splitter; and the second beam splitter directs the Raman-scattered light to the spectrophotometric detector, which is optically connected to the apparatus to quantitatively detect and record the Raman spectral data.

Embodiment 2 is the apparatus of embodiment 1, further comprising a laser operably connected in optical alignment with the first beam splitter; the laser being adapted and arranged to emit the beam of laser light toward the first beam splitter.

Embodiment 3 is the apparatus of embodiment 2, wherein the laser is operably connected by a first fiberoptic cable through which the laser light is transmitted from the laser to the first beam splitter.

Embodiment 4 is the apparatus of embodiment 2 or 3, wherein the laser is a 532 nm laser.

Embodiment 5 is the apparatus of any one of embodiments 1 to 4, wherein the dichroic filter is a bandpass dichroic filter.

Embodiment 6 is the apparatus of any one of embodiments 1 to 5, further comprising a spectrophotometric detector operably connected in optical alignment with the second beam splitter to quantitatively detect and record the Raman spectral data.

Embodiment 7 is the apparatus of any one of embodiments 2 to 6, wherein the spectrophotometric detector is operably connected by a second fiberoptic cable through which the Raman-scattered light is transmitted from the second beam splitter to the detector.

Embodiment 8 is the apparatus of any one of embodiments 1 to 7, operably mounted above the web of the continuous coating apparatus for two- or three-dimensional movement over the coating web.

Embodiment 9 is the apparatus of any one of embodiments 1 to 8, further comprising:
a lamp operably connected in optical alignment with the first beam splitter; such that light from the lamp is transmitted to the dichroic filter, and from the dichroic filter to the scanning mirror; and
an imager operably connected in optical alignment with the second beam splitter to receive light from the second beam splitter and record an image of the surface of the coating;
wherein, in use, the light from the lamp is directed by the first beam splitter to the dichroic filter, from the dichroic filter to the scanning mirror, and from the scanning mirror through the objective lens assembly to illuminate the coating on the moving web; and light reflected from the coating passes back through the objective lens assembly to the scanning mirror, from the scanning mirror to the dichroic filter, from the dichroic filter to the second beam splitter, and from the second beam splitter to the imager to record an image of the coating on the moving web.

Embodiment 10 is the apparatus of embodiment 9, operably mounted above the web of the continuous coating apparatus for two- or three-dimensional movement over the coating web.

Embodiment 11 is an apparatus comprising:
(a) a laser adapted and arranged to emit a beam of laser light;
(b) a first beam splitter mounted on a support framework; the first beam splitter being adapted and arranged to reflect the beam of laser light emitted by the laser;
(c) a scanning mirror mounted on the support framework;
(d) an objective lens assembly mounted on the support framework optically aligned with the scanning mirror to receive light reflected from the scanning mirror; the scanning mirror being adapted and arranged for rotational movement to scan the beam of laser light through the objective lens assembly;
(e) a dichroic filter mounted on the support framework between and optically aligned with the first beam splitter and the scanning mirror; the dichroic filter being transparent to the beam of laser light and reflective to Raman-scattered light from a Raman-active analyte illuminated by the beam of laser light;
(f) a second beam splitter mounted on the support framework spaced from and optically aligned with the dichroic filter to receive the Raman-scattered light from the dichroic filter; and
(g) a spectrophotometric detector operably connected in optical alignment with the second beam splitter to receive the Raman-scattered light from the second beam splitter to quantitatively detect and record Raman spectral data from the Raman-scattered light;
wherein, in use, the first beam splitter directs the beam of laser light through the dichroic filter to the scanning mirror; the scanning mirror continuously scans the beam of laser light through the objective lens assembly across the width of a coating comprising the analyte, which coating has been deposited on a moving web by a continuous coating apparatus; at least a portion of the Raman-scattered light from the analyte in the coating is directed by the objective lens assembly back to the scanning mirror; the scanning mirror reflects the Raman-scattered light to the dichroic filter; the dichroic filter reflects the Raman-scattered light to the second beam splitter; and the second beam splitter directs the Raman-scattered light to the spectrophotometric detector for quantitative detection and recording of the Raman spectral data.

Embodiment 12 is the apparatus of embodiment 11, wherein the laser is operably connected by a first fiberoptic cable through which the laser light is transmitted from the laser to the first beam splitter; and/or the spectrophotometric detector is operably connected by a second fiberoptic cable through which the Raman-scattered light is transmitted from the second beam splitter to the detector.

Embodiment 13 is the apparatus of embodiment 11 or 12, wherein the laser is a 532 nm laser.

Embodiment 14 is the apparatus of any one of embodiments 11 to 13, wherein the dichroic filter is a bandpass dichroic filter.

Embodiment 15 is the apparatus of any one of embodiments 11 to 14, operably mounted above the web of the continuous coating apparatus for two- or three-dimensional movement over the coating web.

Embodiment 16 is the apparatus of any one of embodiments 11 to 15, further comprising:
a lamp operably connected in optical alignment with the first beam splitter; such that light from the lamp is transmitted to the dichroic filter, and from the dichroic filter to the scanning mirror; and
an imager operably connected in optical alignment with the second beam splitter to receive light from the second beam splitter and record an image of the surface of the coating;
wherein, in use, the light from the lamp is directed by the first beam splitter to the dichroic filter, from the dichroic filter to the scanning mirror, and from the scanning mirror through the objective lens assembly to illuminate the coating on the moving web; and light reflected from the coating passes back through the objective lens assembly to the scanning mirror, from the scanning mirror to the dichroic filter, from the dichroic filter to the second beam splitter, and from the second beam splitter to the imager to record an image of the coating on the moving web.

Embodiment 17 is a method for monitoring defects and/or coating composition uniformity in a continuous coating process, the method comprising the steps of:
(a) mounting the apparatus of claim 1 above a coating web of a continuous roll-to-roll coating apparatus;
(b) advancing the web from a feeder roll to a receiving roll while depositing a coating comprising at least one Raman-active component on the advancing web;
(c) emitting a beam of laser light toward the first beam splitter of the apparatus, which thereby directs the beam of laser light through the dichroic filter to the scanning mirror; the scanning mirror rotates to continuously scan the beam of laser light through the objective lens assembly across the width of the coating; at least a portion of the Raman-scattered light from the Raman-active material in the coating is directed by the objective lens assembly to the scanning mirror; the scanning mirror reflects the Raman-scattered light to the dichroic filter; the dichroic filter reflects the Raman-scattered light to the second beam splitter; and the second beam splitter directs the Raman-scattered light to a spectrophotometric detector that is optically connected to the apparatus to detect and record Raman spectral data from the moving coating; and
(d) analyzing the spectral data detected in step (c) to evaluate coating thickness uniformity and/or uniformity of distribution of the Raman-active material in the coating.

Embodiment 18 is the method of embodiment 17, further comprising halting movement of the web, moving the apparatus to selected positions over the coating, and analyzing Raman scattering from the coating at the selected positions.

Embodiment 19 is a method for monitoring defects and/or coating composition uniformity in a continuous coating process, the method comprising the steps of:
(a) mounting the apparatus of any one of embodiments 11 to 16 above a coating web of a continuous roll-to-roll coating apparatus;
(b) advancing the web from a feeder roll to a receiving roll and while depositing a coating comprising at least one Raman-active component on the advancing web;
(c) emitting a beam of laser light toward the first beam splitter of the apparatus, which thereby directs the beam of laser light through the dichroic filter to the scanning mirror; the scanning mirror rotates to continuously scan the beam of laser light through the objective lens assembly across the width of the coating; at least a portion of the Raman-scattered light from the Raman-active material in the coating is directed by the objective lens assembly to the scanning mirror; the scanning mirror reflects the Raman-scattered light to the dichroic filter; the dichroic filter reflects the Raman-scattered light to the second beam splitter; and the second beam splitter directs the Raman-scattered light to a spectrophotometric detector that is optically connected to the apparatus to continuously detect and record Raman spectral data from the moving coating; and
(d) analyzing the spectral data detected in step (c) to evaluate coating thickness uniformity and/or uniformity of distribution of the Raman-active material in the coating.

Embodiment 20 is the method of embodiment 19, further comprising, while the laser is turned off:
(e) directing light from the lamp toward the first beam splitter; such that the light from the lamp is transmitted to the dichroic filter, from the dichroic filter to the scanning mirror; and from the scanning mirror through the objective lens assembly to illuminate the coating on the moving web; whereby light reflected from the coating passes back through the objective lens assembly to the scanning mirror, from the scanning mirror to the dichroic filter, from the dichroic filter to the second beam splitter, and from the second beam splitter to the imager to record an image of the coating on the moving web; and
(f) analyzing the image from step (e) to visually evaluate coating uniformity.

The apparatus and methods described herein comprise certain novel features hereinafter fully described, which are illustrated in the accompanying drawings and the following description, and which are particularly pointed out in the appended claims. It is to be understood that various changes in the details may be made without departing from the spirit, or sacrificing any of the advantages of the apparatus and methods described herein.

### BRIEF DESCRIPTION OF THE DRAWINGS

FIG. 1 provides a schematic illustration of an embodiment of the apparatus described herein mounted in relation to the moving web of a continuous coating apparatus.

FIG. 2 provides a schematic illustration of an embodiment of the apparatus described herein mounted in relation to the moving web of a continuous coating apparatus.

FIG. 3 provides Raman scattering spectral data from films comprising lithium lanthanum zirconium oxide (LLZO) nanoparticles and trifluoromethanesulfonimidate (LiTFSI) salt embedded in polyethylene oxide (PEO) at different LLZO concentrations.

### DETAILED DESCRIPTION OF THE PRESENT INVENTION

Raman scattering is a useful technique for quantitatively determining film/coating thickness for films and coatings containing Raman-active components. The thickness of a coating or film can be estimated based on the intensity of reflected Raman scattering signals, using calibration samples of known coating thicknesses to generate a calibration curve. For convenience, the terms “coating” and “film” will be used interchangeably to refer to relatively thin layers of a material deposited on a web or substrate. The thickness and composition of coatings containing Raman-active substances can even be performed simultaneously using transfer matrix models.

Light interacts with certain materials to scatter at frequencies that differ from the frequency of the illuminating light—this is called Raman scattering. When coherent light from a laser is used to irradiate a Raman-active substance, the resulting Raman-scattered light is shifted by specific characteristic frequencies from that of the irradiating light. A typical laser wavelength for Raman spectroscopy is 532 nm. Typical cathode materials for lithium battery electrodes that are coated onto current collectors have distinct identifiable Raman scattering frequencies, for example, carbon materials (1325 and 1580 cm⁻¹), lithium fluorophosphate (950 cm⁻¹), and lithium nickel cobalt manganese oxide (NCM; 494, 597 and 630 cm⁻¹). Thus, Raman scattering can be used to identify and quantify these cathode analytes in a cathode coating. Raman scattering can also be used to extract spatial distribution of active materials and electron conductors by scanning for Raman scattering signals across the coating surface and generating computational Raman spectral mapping.

There are commercial software programs available for Raman mapping from vendors such as Edinburgh Instruments, Horiba, etc, that sell Raman Microscopes or Spectrometers attached with an XYZ stage to do Raman mapping with their own software (see for example the website: www (dot) edinst (dot) com/blog/mapping-the-raman-spectra/). Such software is useful for samples and films post-synthesis or post-processing, not in situ. In addition, the following articles discuss Raman mapping: Dorián László Galata, et al., Journal of Pharmaceutical and Biomedical Analysis, Vol. 212, (2022); Oleksii Ilchenko, et al., Nature Communications, Vol. 10, Article Number: 5555 (2019); and Esmonde-White, F. W., Morris, M. D., Raman Imaging and Raman Mapping; In: Matousek, P., Morris, M. (eds) Emerging Raman Applications and Techniques in Biomedical and Pharmaceutical Fields; Biological and Medical Physics, Biomedical Engineering. Springer, Berlin, Heidelberg, DOI 10.1007/978-3-642-02649-2_5.

An apparatus suitable for monitoring coating defects and/or for monitoring coating composition uniformity comprises a first beam splitter mounted on a support framework; an objective lens assembly mounted on the support framework spaced from the first beam splitter; a scanning mirror mounted on the support framework interposed between the first beam splitter and the objective lens assembly; a dichroic filter mounted on the support framework interposed between the first beam splitter and the scanning mirror; and a second beam splitter mounted on the support framework. The first beam splitter is adapted and arranged to receive a beam of laser light emitted from a laser, and to direct the beam of laser light to the dichroic filter. The dichroic filter is transparent to the beam of laser light and reflective to Raman-scattered light from an a Raman-active analyte illuminated by the beam of laser light, so that the laser light can pass through the filter to the scanning mirror. The scanning mirror is adapted and arranged for scanning the beam of laser light through the objective lens assembly, so that the laser light continuously scans across the coating when exiting the objective lens assembly. When the laser light interacts with a Raman-active substance (an analyte) in the coating, at least a portion of Raman-scattered light from the analyte enters the objective lens assembly and is focused onto the scanning mirror. The scanning mirror then reflects the Raman-scattered light back to the dichroic filter, which reflects the Raman-scattered light to the second beam splitter. The second beam splitter is adapted and arranged to direct the Raman-scattered light to a spectrophotometric detector operably connected in optical alignment with the second beam splitter to quantitatively detect and record Raman spectral data related to the analyte in the coating.

In a typical use, the apparatus is optically connected to a laser that emits the beam of laser light toward the first beam splitter, which directs the beam of laser light through the dichroic filter to the scanning mirror. The scanning mirror rotates to continuously scan the beam of laser light through the objective lens assembly across the width of a coating comprising the analyte, which has been deposited on a moving web by a continuous coating apparatus. The laser light irradiates the Raman-active analyte (e.g., a lithium battery component, such as NCM) in the coating (e.g., an electrode coating for a lithium battery), and the analyte generates Raman scattering. At least a portion of the Raman-scattered light from the analyte in the coating is directed by the objective lens assembly to the scanning mirror; the scanning mirror directs the Raman-scattered light to the dichroic filter; the dichroic filter directs the Raman-scattered light to the second beam splitter; and the second beam splitter directs the Raman-scattered light to a spectrophotometric detector that is optically connected to the apparatus to detect and record the Raman spectral data related to the analyte in the coating. The quantitative intensities of the Raman scattering frequencies of the analyte (Raman spectral data) detected by the detector are then used to calculate the film thickness and/or the uniformity of the distribution of the Raman-active analyte in the coating using calibration against known thickness coatings and known Raman mapping techniques.

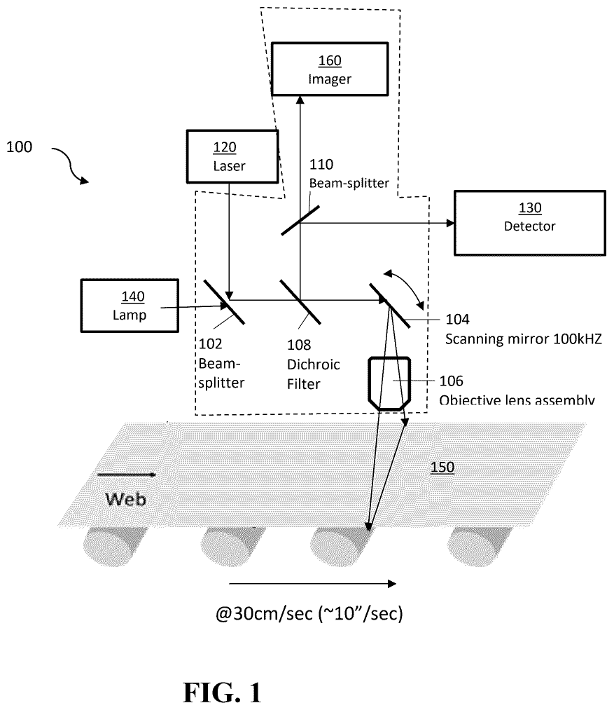

Referring now to the drawings, FIG. 1 provides a schematic illustration of an embodiment of the apparatus described herein in use with a continuous coating apparatus. Support framework elements for mounting the components of the apparatus are omitted for clarity to illustrate the working components and their spatial relationship to each other.

Apparatus 100 comprises a first beam splitter 102 and scanning mirror 104, with dichroic filter 108 optically aligned in a direct path between beam splitter 102 and scanning mirror 104. Laser 120 is positioned relative to first beam splitter 102 such that beam splitter 102 directs laser light from laser 120 at a 90 degree angle to pass through dichroic filter 108 to scanning mirror 106 during use. Objective lens assembly 106 is positioned relative to scanning mirror 104 to receive the laser light reflected off scanning mirror 104 onto a coating (not shown) deposited on the moving web 150 of a continuous coating apparatus. Second beam splitter 110 is aligned with dichroic filter 108 at a 90 degree angle from the alignment of first beam slitter 102 with dichroic filter 108. Spectrophotometric detector 130 is aligned with beam splitter 110 at a 90 degree angle from the alignment of beam spitter 110 with dichroic filter 108. Lamp 140 is positioned in alignment with beam splitter 102 at a 90 degree angle from the alignment of laser 120 with beam splitter 102. Video imager 160 is spaced from beam splitter 110 and positioned in direct optical alignment with beam splitter 110 and dichroic filter 108.

Lamp 140 and imager 160 are used for obtaining a video image of the coating on the moving web when laser 120 is turned off. Light from lamp 140 passes through first beam splitter 102 and dichroic filter 108 to scanning mirror 104, where the light is then reflected through objective lens assembly 106 to illuminate the surface of the coating. Lamp light reflected from the surface of the coating passes back through objective lens assembly 106 to scanning mirror 104, which reflects the light back to dichroic filter 108. From there, the light is reflected by dichroic filter 108 to second beam splitter 110 where the reflected light passes through beam splitter 110 to video imager 160, where a video image of the moving coating surface is recorded.

In use, a coating is deposited on web 150, which is moving at up to 30 cm/second (approximately 10 inches per second). A beam of laser light is emitted by laser 120, which is directed by first beam splitter 102 through dichroic filter 108 to scanning mirror 104. Scanning mirror 104 rotates to continuously scan the beam of laser light through objective lens assembly 106 across the width of the moving coating at a scanning rate of up to 10 kHz. Raman-active materials in the coating illuminated by the laser light emit Raman-scattered light, a portion of which travels back through objective lens assembly 106 to scanning mirror 104, which reflects the Raman-scattered light to dichroic filter 108 and on to second beam splitter 110. The Raman scattered light is directed by beam splitter 110 to spectrophotometric detector 130 for quantitative detection. If a visual image of the coating surface is desired, lamp 140 and imager 160 are used, as described above, while laser 120 is off.

Additionally, the moving web can be halted and high-resolution Raman spectral data can be collected with apparatus 100 on selected portions of the coating, if desired, in substantially the same manner of operation as for Raman scanning of the moving coating. Typically, apparatus 100 is mounted above coating web 150 in a manner that allows the apparatus to be moved in a plane substantially parallel to the web and also to adjust the vertical position of the objective lens assembly above the coating (e.g., to adjust the focus).

The intensities of the detected Raman signals from the analytes in the coating are used to determine coating thickness using known techniques, such as calibration using coatings of known thickness, and/or map the distribution of the analytes in the coating during the coating operation, in real time, using computational mapping techniques. In some embodiments, a feedback loop from the Raman signal detected by the detector can be used in conjunction with control software and hardware to modify coating equipment parameters to adjust the coating thickness and/or spatial distribution of the analyte in the coating.

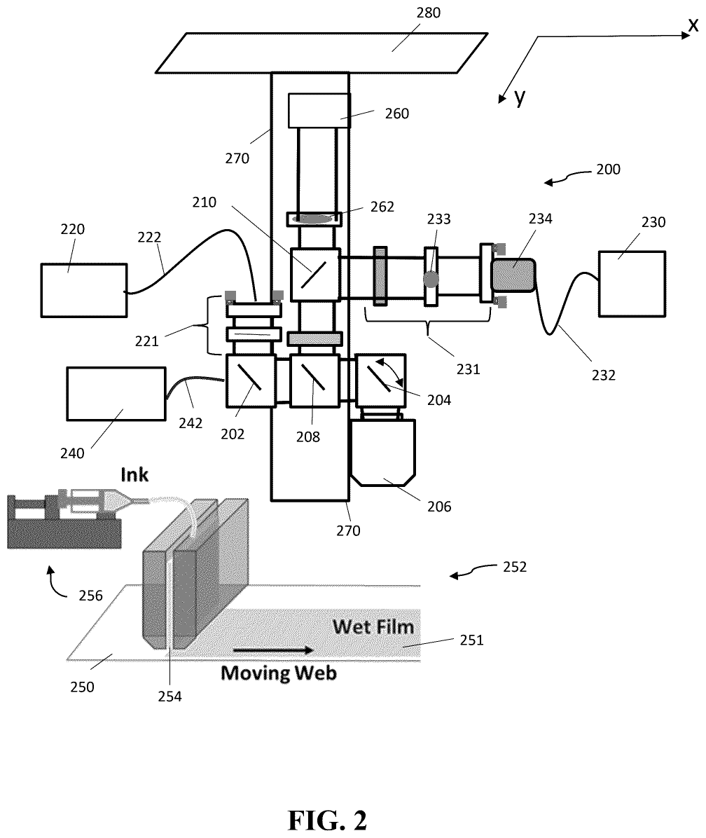

FIG. 2 schematically illustrates an embodiment of the apparatus mounted over a moving coating web 250 of a continuous coating apparatus 252 during use. Apparatus 200 comprises a first beam splitter 202 optically aligned with scanning mirror 204. Dichroic filter 208 is optically aligned directly between beam splitter 202 and scanning mirror 204. Scanning mirror 204 is optically aligned with objective lens assembly 206 and dichroic filter 208, so that light reflected from scanning mirror 204 passes through objective lens assembly 206. Second beam splitter 210 is optically aligned with dichroic filter 208 at a 90 degree angle from the alignment of first beam splitter 202 with dichroic filter 208, so as to receive light reflected from dichroic filter 208 and direct it through imaging assembly 262 toward video imager 260 or through aperture 233 in port 231 to fiberoptic interface 234. Fiberoptic interface 234 is optically connected to fiberoptic cable 232, which is optically connected to spectrophotometric detector 230. Laser 220 is optically connected to fiberoptic cable 222, which is optically connected to laser interface assembly 221, such that light from laser 220 is directed toward first beam splitter 202, in use.

Dichroic filter 208, beam splitter 210, aperture assembly 262, and imager 260 are all mounted within housing 270 and are optically aligned in a straight path. Second beam splitter 202 is mounted on housing 270, and laser interface 221 is mounted on housing 270 above beam splitter 202. Housing 270 is operably mounted on movable carriage 280, which is adapted for two-dimensional movement of apparatus 200 in an x-y plane that is uniformly spaced from coating web 250 of coating apparatus 252. Lamp 240 is operably interfaced with beam splitter 202 by fiberoptic cable 242, aligned so that light from lamp 240 strikes beamsplitter 202 at a 90 degree angle relative to light from laser 220.

Lamp 240 and imager 260 are used for obtaining a video image of the coating on the moving web when laser 120 is turned off. Light from lamp 240 passes through beam splitter 202 and dichroic filter 208 to scanning mirror 204, where the light is then reflected through objective lens assembly 106 to illuminate the surface of the coating. Lamp light reflected from the surface of the coating passes back through objective lens assembly 206 to scanning mirror 204, which reflects the light back to dichroic filter 208. From there, the light is reflected by dichroic filter 208 to beam splitter 210 where the reflected light passes through beam splitter 210 to video imager 260, where a video image of the moving coating surface is recorded.

Apparatus 200 is operated in substantially the same manner as apparatus 100 of FIG. 1, as described above. During use, a coating formulation (also known as “ink”) is pumped into coating slot 254 by pump 256 to lay down coating 251 on moving web 250. Web 250 oves at up to 30 cm/second (approximately 10 inches per second). A beam of laser light is emitted by laser 220, which is directed by first beam splitter 202 through dichroic filter 208 to scanning mirror 204. Scanning mirror 204 rotates to continuously scan the beam of laser light through objective lens assembly 206 across the width of the moving coating 251 at a scanning rate of up to 10 KHz. Raman-active materials in coating 251 illuminated by the laser light emit Raman-scattered light, a portion of which travels back through objective lens assembly 206 to scanning mirror 204, which reflects the Raman-scattered light to dichroic filter 208 and on to second beam splitter 210. The Raman scattered light is directed by beam splitter 210 to spectrophotometric detector 230 for quantitative detection. If a visual image of the coating surface is desired, lamp 240 and imager 260 are used, as described above, while laser 220 is off.

Various embodiments of the apparatus and methods described herein provide a number of advantages for monitoring coating processes, including:
Real-time characterization of (1) film surface morphology and (2) Raman signal, in order to track quality of the film (thickness and defects distribution) in situ during the coating process.
Interchangeable modes between (1) fast line-scans of film to track quality of the produced film (scan approximately 1 inch per 100 milliseconds (ms), with 10 time integration to achieve 10 inch/sec acquisition (comparable to film rolling rate on a roll-to-roll coater); and (2) a movable mounting to position the apparatus to scan 30 cm wide coating, with fine resolution sampling at a spatial resolution of approximately 0.5 μm.
Utilizing a 532 nm laser a Raman scattering frequency shift range of about 100 about 1000 cm⁻¹ can be obtained.
The apparatus can be constructed from over-the-counter optics and light weight cage optics that are cost effective.
The apparatus can be integrated into a control system to provide feedback control from the Raman signal output of the spectrophotometric detector to the coating equipment, e.g., using the Raman results to adjust coating parameters during the coating process.

In some embodiments, the apparatus is mounted for two-dimensional movement in a plane that is substantially uniformly spaced from the surface of the coating web and/or for three-dimensional movement over the coating web. Non limiting examples of mountings for movement of the apparatus over the web include: a movable carriage mounted on a frame above the web for two dimensional movement of the apparatus in a plane that is uniformly spaced from the web; and an articulating arm suspended over the coating web in which the apparatus is mounted for two- or three-dimensional movement over the web. The apparatus is mounted at a suitable distance from the web for achieving proper focus of the laser light onto the web and for focus of the Raman-scattered light from the analyte in the coating by the objective lens assembly to the scanning mirror.

In some embodiments, the support framework for the apparatus components comprises a housing defining one or more apertures to allow light to pass through the housing, and mountings within or on the housing for attaching the optical elements of the apparatus (e.g., the laser, the beam splitters, the dichroic filter, the scanning mirror, the objective lens assembly, the lamp, the spectrophotometric detector, and the video imager) in operative optical alignment. In some embodiments; the support framework for the apparatus comprises open support elements (e.g., rods, bars, braces, and the like) mounted on one or more base frames, and mountings on the open support elements or base frames for attaching the optical elements of the apparatus, as described above, in operative optical alignment. In some embodiments, the support framework for the apparatus comprises a combination of the housing as described above, and the open support elements as described above.

Beam splitters are well known in the optics art. Non-limiting examples of suitable beam splitters useful in the apparatus described herein include, e.g., UV fused silica plate 50/50 beamsplitter (e.g., Thorlabs, BSW29), a cube beamsplitter (e.g., Thorlabs, BS011), and polarizing plate beamsplitters (e.g., Thorlabs, PBSW-532). The beam splitters can be mounted in their own housing or framework, if desired. As is well known in the art, beam splitters are partially reflective, partially transmissive optical elements that are oriented at a 45 degree angle to incident light (e.g., a beam of laser light). When light interacts with a beam splitter, a portion of the light passes through in a straight path and a portion is reflected from the incident surface at a 90 degree angle.

Dichroic filters are designed to selectively allow wavelengths within a specific transmission band to pass through while reflecting all other wavelengths. Dichroic filters suitable for use in the apparatus described herein include, e.g., longpass filters, which transmit all wavelengths above a given cut-on wavelength; shortpass filters, which transmit wavelengths below a given cut-off; and bandpass filters will transmit wavelengths. The dichroic filter for the apparatus designed herein is selected based on the laser wavelength to be transmitted through the filter, as well as for the range of Raman-scattering to be reflected by the filter. Non-limiting examples of suitable dichroic filters include, e.g. longpass dichroic mirrors (Thorlabs, DMLP550), and shortpass dichronic mirrors (Thorlabs, DMSP550).

Scanning mirrors typically are rotating mirrors that can continuously scan laser light across a surface. Scanning mirrors suitable for use in the apparatus described herein are well known in the optics art, and preferably have the ability to scan at a rate of up to 100 KHz. Non-limiting examples of suitable scanning mirrors include, e.g., 1D SCANNING GALVANOMETER (Thorlabs, GVS001), and 2D SCANNING GALVANOMETER (Thorlabs, GVS002). The scanning mirror will be adapted for connection to a power source, and typically will be mounted in its own housing or framework, with an electric motor operably connected to the mirror.

Objective lens assemblies are well known in the optics art. The objective lens assembly can comprise a single lens or multiple lenses, housed in a lens barrel. Each lens can be a simple lens or a compound lens. The objective lens assembly can include other elements such as diaphragms, fine focusing mechanisms, baffles, and any other element commonly used in optical lenses. Non-limiting examples of suitable objective lens assemblies include, e.g., long working distance VIS objectives with high magnification (Thorlabs, MY50X-825), and long working distance VIS objectives with low magnification (Thorlabs, MY10X-825) to switch between sampling spot size.

Lasers are well known on the optics art. The laser can be mounted on the housing or support framework for the apparatus, or can be separately mounted to operably align with the apparatus. The laser light can be conveyed into the apparatus directly or via an optical pathway, such as a fiber optic cable.

Lamps are well known on the optics art. Non-limiting examples of suitable lamps for use in conjunction with the apparatus described herein include, e.g., diode CW lasers (Hubner, COBOLT 06-01 series), and fiber coupled laser diode (QPhotonics, QFLD-20-10S). The lamp can be mounted on the housing or support framework for the apparatus, or can be separately mounted to operably align with the apparatus. The light from the lamp can be conveyed into the apparatus directly or via an optical pathway, such as a fiberoptic cable.

Video imagers suitable for use in conjunction with the apparatus described herein are well known in the art. Non-limiting examples of suitable video imagers include, e.g., CMOS compact scientific digital cameras (Thorlabs, CS165MU), and microscopy cameras (Edmunds Optics, 25-351). The imager can be mounted on or in the housing or support framework for the apparatus, or can be separately mounted to operably align with the apparatus.

Spectrophotometric detectors suitable for use in conjunction with the apparatus described herein are well known in the art. Non-limiting examples of suitable spectrophotometric detectors include, e.g., PIXIS camera (Teledyne, PIX-400BR), deep cooled UV/VIS.NIR camera (Horiba Scientific, SYNCERITY). The detector can be mounted on the housing or support framework for the apparatus, or can be separately mounted to operably align with the apparatus. The laser light can be conveyed into the apparatus directly or via an optical pathway, such as a fiber optic cable.

The following non-limiting examples are provided to illustrate certain aspects and features of the materials and methods described herein.

### Example 1. Characterization of PEO Membrane with Raman Spectroscopy

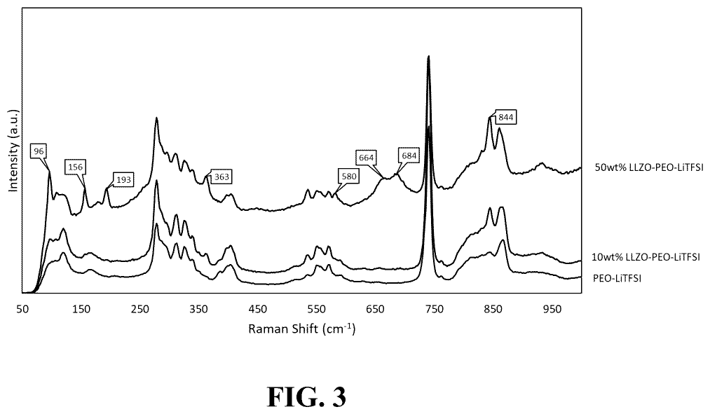

As an example, PEO based membranes were prepared with LiTFSI and LLZO nanoparticles with different weight loading. The prepared membrane samples were characterized by Raman spectroscopy (RENISHAW INVIA). The Raman spectrum was collected with 523 nm laser with 100% of laser power. The exposure time was maintained to 1 second and 10-20 spectra were accumulated and combined for the spectrum. FIG. 3 shows Raman spectrum of PEO-LiTFSI, 10 wt % LLZO-PEO-LiTFSI, and 50 wt % LLZO-PEO-LiTFSI. Compared to PEO-LiTFSI, LLZO containing samples shows extra peaks at around 100-200 cm⁻¹, 363 cm⁻¹, and 600-700 cm⁻¹. Bands at 100-150 cm⁻¹ can be assigned to vibration of La cation, at 200-300 cm⁻¹ is attributed to oxygen bending modes, at 300-600 cm⁻¹ is from the Li vibration, and 600-700 cm⁻¹ can be assigned to Zr—O vibration. This indicates that the Raman signal of embedded LLZO in PEO matrix can be detected. Moreover, the peak intensity of LLZO related peak was increased with increasing LLZO loading, demonstrating that the peak intensity can be used to quantify the LLZO contents with calibration.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing materials or methods (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The terms “consisting of” and “consists of” are to be construed as closed terms, which limit any compositions or methods to the specified components or steps, respectively, that are listed in a given claim or portion of the specification. In addition, and because of its open nature, the term “comprising” broadly encompasses compositions and methods that “consist essentially of” or “consist of” specified components or steps, in addition to compositions and methods that include other components or steps beyond those listed in the given claim or portion of the specification. Recitation of ranges of values herein are merely intended to serve as a shorthand method of referring individually to each separate value falling within the range, unless otherwise indicated herein, and each separate value is incorporated into the specification as if it were individually recited herein. All numerical values obtained by measurement (e.g., weight, concentration, physical dimensions, removal rates, flow rates, and the like) are not to be construed as absolutely precise numbers, and should be considered to encompass values within the known limits of the measurement techniques commonly used in the art, regardless of whether or not the term “about” is explicitly stated. All methods described herein can be performed in any suitable order unless otherwise indicated herein or otherwise clearly contradicted by context. The use of any and all examples, or exemplary language (e.g., “such as”) provided herein, is intended merely to better illuminate certain aspects of the materials or methods described herein and does not pose a limitation on the scope of the claims unless otherwise stated. No language in the specification should be construed as indicating any non-claimed element as essential to the practice of the claims.

Preferred embodiments are described herein, including the best mode known to the inventors for carrying out the claimed invention. Variations of those preferred embodiments may become apparent to those of ordinary skill in the art upon reading the foregoing description. The inventors expect skilled artisans to employ such variations as appropriate, and the inventors intend for the claimed invention to be practiced otherwise than as specifically described herein. Accordingly, the claimed invention includes all modifications and equivalents of the subject matter recited in the claims appended hereto as permitted by applicable law. Moreover, any combination of the above-described elements in all possible variations thereof is encompassed by the claimed invention unless otherwise indicated herein or otherwise clearly contradicted by context.

The embodiments if the invention in which an exclusive property or privilege is claimed are defined as follows:

1. An apparatus comprising:
(a) a first beam splitter mounted on a support framework, the first beam splitter being adapted and arranged to receive a beam of laser light emitted from a laser;
(b) a scanning mirror mounted on the support framework;
(c) an objective lens assembly mounted on the support framework optically aligned with the scanning mirror to receive light reflected from the scanning mirror; the scanning mirror being adapted and arranged for rotational movement to scan the beam of laser light through the objective lens assembly;
(d) a dichroic filter mounted on the support framework interposed between and optically aligned with the first beam splitter and the scanning mirror; the dichroic filter being transparent to the beam of laser light and reflective to Raman-scattered light from a Raman-active analyte illuminated by the beam of laser light; and
(e) a second beam splitter mounted on the support framework spaced from and optically aligned with the dichroic filter to reflect the Raman-scattered light to a spectrophotometric detector to collect Raman spectral data;
wherein, in use, the apparatus is optically connected to a laser that emits the beam of laser light toward the first beam splitter, which directs the beam of laser light through the dichroic filter to the scanning mirror; the scanning mirror rotates to continuously scan the beam of laser light through the objective lens assembly across the width of a coating comprising the analyte, which has been deposited on a moving web by a continuous coating apparatus; at least a portion of the Raman-scattered light from the analyte in the coating is directed by the objective lens assembly to the scanning mirror; the scanning mirror reflects the Raman-scattered light to the dichroic filter; the dichroic filter reflects the Raman-scattered light to the second beam splitter; and the second beam splitter directs the Raman-scattered light to the spectrophotometric detector, which is optically connected to the apparatus to quantitatively detect and record the Raman spectral data.

2. The apparatus of claim 1, further comprising a laser operably connected in optical alignment with the first beam splitter; the laser being adapted and arranged to emit the beam of laser light toward the first beam splitter.

3. The apparatus of claim 2, wherein the laser is operably connected by a first fiberoptic cable through which the laser light is transmitted from the laser to the first beam splitter.

4. The apparatus of claim 2, wherein the laser is a 532 nm laser.

5. The apparatus of claim 1, wherein the dichroic filter is a bandpass dichroic filter.

6. The apparatus of claim 1, further comprising a spectrophotometric detector operably connected in optical alignment with the second beam splitter to quantitatively detect and record the Raman spectral data.

7. The apparatus of claim 2, wherein the spectrophotometric detector is operably connected by a second fiberoptic cable through which the Raman-scattered light is transmitted from the second beam splitter to the detector.

8. The apparatus of claim 1, operably mounted above the web of the continuous coating apparatus for two- or three-dimensional movement over the coating web.

9. The apparatus of claim 1, further comprising:
a lamp operably connected in optical alignment with the first beam splitter; such that light from the lamp is transmitted to the dichroic filter, and from the dichroic filter to the scanning mirror; and
an imager operably connected in optical alignment with the second beam splitter to receive light from the second beam splitter and record an image of the surface of the coating;
wherein, in use, the light from the lamp is directed by the first beam splitter to the dichroic filter, from the dichroic filter to the scanning mirror, and from the scanning mirror through the objective lens assembly to illuminate the coating on the moving web; and light reflected from the coating passes back through the objective lens assembly to the scanning mirror, from the scanning mirror to the dichroic filter, from the dichroic filter to the second beam splitter, and from the second beam splitter to the imager to record an image of the coating on the moving web.

10. The apparatus of claim 9, operably mounted above the web of the continuous coating apparatus for two- or three-dimensional movement over the coating web.

11. An apparatus comprising:
(a) a laser adapted and arranged to emit a beam of laser light;
(b) a first beam splitter mounted on a support framework; the first beam splitter being adapted and arranged to reflect the beam of laser light emitted by the laser;
(c) a scanning mirror mounted on the support framework;
(d) an objective lens assembly mounted on the support framework optically aligned with the scanning mirror to receive light reflected from the scanning mirror; the scanning mirror being adapted and arranged for rotational movement to scan the beam of laser light through the objective lens assembly;
(e) a dichroic filter mounted on the support framework between and optically aligned with the first beam splitter and the scanning mirror; the dichroic filter being transparent to the beam of laser light and reflective to Raman-scattered light from a Raman-active analyte illuminated by the beam of laser light;
(f) a second beam splitter mounted on the support framework spaced from and optically aligned with the dichroic filter to receive the Raman-scattered light from the dichroic filter; and
(g) a spectrophotometric detector operably connected in optical alignment with the second beam splitter to receive the Raman-scattered light from the second beam splitter to quantitatively detect and record Raman spectral data from the Raman-scattered light;
wherein, in use, the first beam splitter directs the beam of laser light through the dichroic filter to the scanning mirror; the scanning mirror continuously scans the beam of laser light through the objective lens assembly across the width of a coating comprising the analyte, which coating has been deposited on a moving web by a continuous coating apparatus; at least a portion of the Raman-scattered light from the analyte in the coating is directed by the objective lens assembly back to the scanning mirror; the scanning mirror reflects the Raman-scattered light to the dichroic filter; the dichroic filter reflects the Raman-scattered light to the second beam splitter; and the second beam splitter directs the Raman-scattered light to the spectrophotometric detector for quantitative detection and recording of the Raman spectral data.

12. The apparatus of claim 11, wherein the laser is operably connected by a first fiberoptic cable through which the laser light is transmitted from the laser to the first beam splitter; and/or the spectrophotometric detector is operably connected by a second fiberoptic cable through which the Raman-scattered light is transmitted from the second beam splitter to the detector.

13. The apparatus of claim 11, wherein the laser is a 532 nm laser.

14. The apparatus of claim 11, wherein the dichroic filter is a bandpass dichroic filter.

15. The apparatus of claim 11, operably mounted above the web of the continuous coating apparatus for two- or three-dimensional movement over the coating web.

16. The apparatus of claim 11, further comprising:
a lamp operably connected in optical alignment with the first beam splitter; such that light from the lamp is transmitted to the dichroic filter, and from the dichroic filter to the scanning mirror; and
an imager operably connected in optical alignment with the second beam splitter to receive light from the second beam splitter and record an image of the surface of the coating;
wherein, in use, the light from the lamp is directed by the first beam splitter to the dichroic filter, from the dichroic filter to the scanning mirror, and from the scanning mirror through the objective lens assembly to illuminate the coating on the moving web; and light reflected from the coating passes back through the objective lens assembly to the scanning mirror, from the scanning mirror to the dichroic filter, from the dichroic filter to the second beam splitter, and from the second beam splitter to the imager to record an image of the coating on the moving web.

17. A method for monitoring defects and/or coating composition uniformity in a continuous coating process, the method comprising the steps of:
(a) mounting the apparatus of claim 1 above a coating web of a continuous roll-to-roll coating apparatus;
(b) advancing the web from a feeder roll to a receiving roll while depositing a coating comprising at least one Raman-active component on the advancing web;
(c) emitting a beam of laser light toward the first beam splitter of the apparatus, which thereby directs the beam of laser light through the dichroic filter to the scanning mirror; the scanning mirror rotates to continuously scan the beam of laser light through the objective lens assembly across the width of the coating; at least a portion of the Raman-scattered light from the Raman-active material in the coating is directed by the objective lens assembly to the scanning mirror; the scanning mirror reflects the Raman-scattered light to the dichroic filter; the dichroic filter reflects the Raman-scattered light to the second beam splitter; and the second beam splitter directs the Raman-scattered light to a spectrophotometric detector that is optically connected to the apparatus to detect and record Raman spectral data from the moving coating; and
(d) analyzing the spectral data detected in step (c) to evaluate coating thickness uniformity and/or uniformity of distribution of the Raman-active material in the coating.

18. The method of claim 17, further comprising halting movement of the web, moving the apparatus to selected positions over the coating, and analyzing Raman scattering from the coating at the selected positions.

19. A method for monitoring defects and/or coating composition uniformity in a continuous coating process, the method comprising the steps of:
(a) mounting the apparatus of claim 9 above a coating web of a continuous roll-to-roll coating apparatus;
(b) advancing the web from a feeder roll to a receiving roll and while depositing a coating comprising at least one Raman-active component on the advancing web;
(c) emitting a beam of laser light toward the first beam splitter of the apparatus, which thereby directs the beam of laser light through the dichroic filter to the scanning mirror; the scanning mirror rotates to continuously scan the beam of laser light through the objective lens assembly across the width of the coating; at least a portion of the Raman-scattered light from the Raman-active material in the coating is directed by the objective lens assembly to the scanning mirror; the scanning mirror reflects the Raman-scattered light to the dichroic filter; the dichroic filter reflects the Raman-scattered light to the second beam splitter; and the second beam splitter directs the Raman-scattered light to a spectrophotometric detector that is optically connected to the apparatus to continuously detect and record Raman spectral data from the moving coating; and
(d) analyzing the spectral data detected in step (c) to evaluate coating thickness uniformity and/or uniformity of distribution of the Raman-active material in the coating.

20. The method of claim 19, further comprising, while the laser is turned off:
(e) directing light from the lamp toward the first beam splitter; such that the light from the lamp is transmitted to the dichroic filter, from the dichroic filter to the scanning mirror; and from the scanning mirror through the objective lens assembly to illuminate the coating on the moving web; whereby light reflected from the coating passes back through the objective lens assembly to the scanning mirror, from the scanning mirror to the dichroic filter, from the dichroic filter to the second beam splitter, and from the second beam splitter to the imager to record a visual image of the coating on the moving web; and
(f) analyzing the visual image from step (e) to visually evaluate coating uniformity.
